(19) United States
(12) Patent Application Publication
(10) Pub. No.: US 2015/0059551 A1
(43) Pub. Date: Mar. 5, 2015

(54) Construction Of Soundboard For Acoustic String Instrument

(71) Applicant: Robert Linn Bailey, II, Cedar Park, TX (US)

(72) Inventor: Robert Linn Bailey, II, Cedar Park, TX (US)

(21) Appl. No.: 14/476,021

(22) Filed: Sep. 3, 2014

(30) Foreign Application Priority Data
Sep. 3, 2013 (CN) 201320543729

(51) Int. Cl. G10D 1/00

(52) U.S. Cl. CPC G10D 1/005
USPC 84/291

(57) ABSTRACT

A soundboard construction for a stringed instrument having back and side panels includes an inner panel having a relief or recess structure impressed in the panel so that the impressions serve as support bracing when the inner panel is joined with an outer panel. This will result in a strong soundboard with consistent tone. The side panel can be integrated with soundboard or with the back panel as a whole. The inner panel includes integrated recesses by molding with a composite material at one time directly, and then combining the inner panel with the decorative outer panel to form the soundboard of the instrument. Manufacturing costs are reduced by reducing use of expensive wood

### CROSS-REFERENCE TO RELATED APPLICATIONS

This application claims the benefit of Chinese Patent Application 2013/20543729, filed on Sep. 3, 2013, and incorporated herein by reference.

### STATEMENT REGARDING FEDERALLY SPONSORED RESEARCH AND DEVELOPMENT

Not Applicable.

### FIELD OF THE INVENTION

This invention relates generally to a sound box for acoustic stringed instrument, especially with regard to a soundboard construction of acoustic string instrument.

### DISCUSSION OF RELATED ART

Traditionally acoustic stringed instruments are made from wood material by luthiers. With regard to the tone of the instrument, wood is selected based on density, strength, decided by woods used in the soundboard, back and side boards of sound box, as well as the whole construction design of support bracing seen from within the sound hole.

For a traditional guitar, normally the support bracing is glued and affix to the inner side of soundboard or back before making the complete sound box. Luthiers can achieve the preferred tone by changing the material of support brace or the location of affixing. Nowadays, the manufacturers of composite musical instruments are trying to improve the tone by changing material and amounts of material at different locations under the soundboard.

Henceforth several shortcomings arise from current luthier production practices:

1. Due to the strict requirements for wood material used in producing a soundboard, as well as the back and side board for sound box, the cost of scarce materials such as spruce, cedar and rosewood is high.

2. By changing the material and location of bracing and materials, luthiers are unable to ensure perfect consistency in tone. This also has an impact on production methods that increase the cost of production.

### SUMMARY OF THE INVENTION

This invention provides a soundboard construction (for either the front or back of the instrument) for the sound box of an acoustic stringed instrument so that the manufacturer can achieve a uniformly produced soundboard and bracing that will result in a stable tone by standardizing the support construction of the soundboard.

In the construction of the soundboard of the acoustic string instrument, the sound box comprises a soundboard and its back and side panels. A top soundboard is a compound panel comprising an outer panel on which a bridge of the instrument is visible, and an inner panel. The inner panel has a relief structure impressed in the panel so that the impressions can serve as support bracing when the two panels are joined together. This results in a strong soundboard with a consistent tone.

The outer side of outer panel is a flat surface. The outer panel may be made with compound materials or a wood material. Further, the outer panel and inner panel may be both made with a layering compound material. The compound material used in the construction may have a variety of weaves or grains such as plain, twill, satin, or mono-directional. The compound material may also be employed with no weave pattern at all.

A bottom side of the top panel is then joined with a top side of the bottom panel to form a single panel. The bottom panel structure is achieved by means of impression such as a stamp or by traditional mold tooling. The bottom panel has recesses in it when looking from above, yet when looking for below it has what appear to be raised sections that look like bracing. Sections of the inner panel may also be cut away or absent from the panel if desired.

Material may also be added into the grooves so as to make tonal adjustments if needed. The outer panel is adhered to the inner panel to form a single panel with a total thickness of between 0.4-3.5 mm at the non-relief sections.

The side panel may or may not be connected with the soundboard as an integrated construction. The side panel may or may not be connected with the back panel as integrated construction.

The present invention utilizes an inner panel of compound material that can be consistently produced for uniform tone. The inner panel can then be used in the construction of an instrument with a soundboard after combining same with the outer panel, which is externally visible and may be then decorated. In this case, not only can we reduce the cost of the instrument by reducing the amount of wood used in the instrument, but we can reduce the manufacturing cost due to the standardization of soundboard and the corresponding support construction. Moreover, this invention makes it is possible to manufacture the instrument with a consistent tone sound by standardizing the soundboard support structure on the soundboard.

### DESCRIPTION OF THE DRAWINGS

FIG. 1 is an exploded view of the invention;

FIG. 2 is a cross-sectional view of the invention; and

FIG. 3 is an exploded view of an alternate embodiment of the invention.

### DETAILED DESCRIPTION OF THE PREFERRED EMBODIMENT

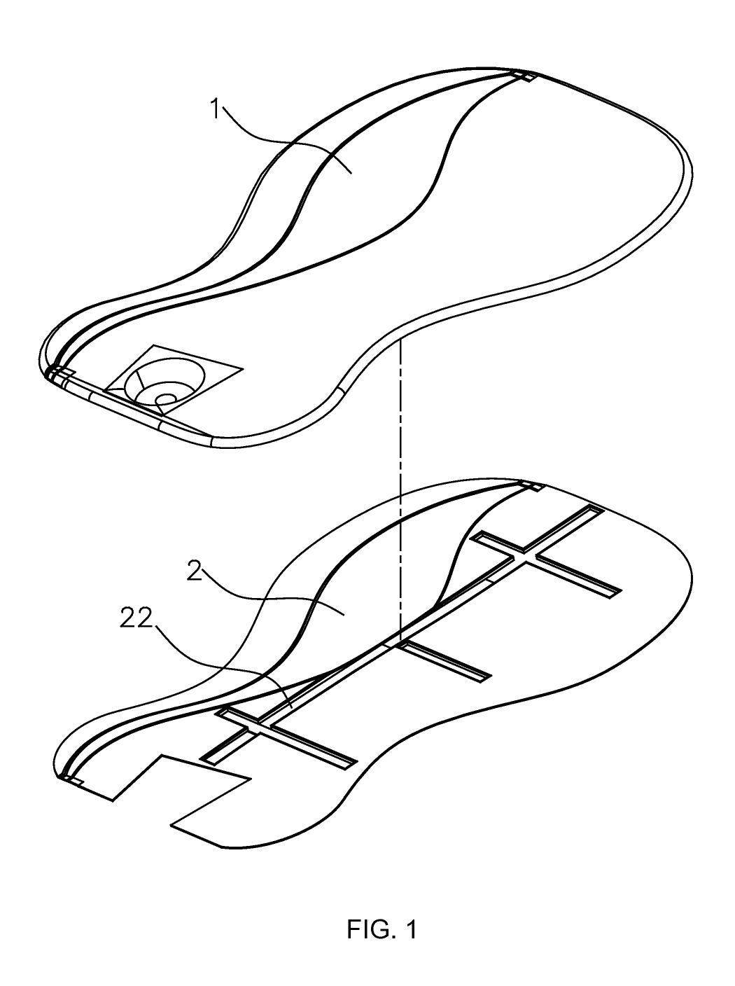

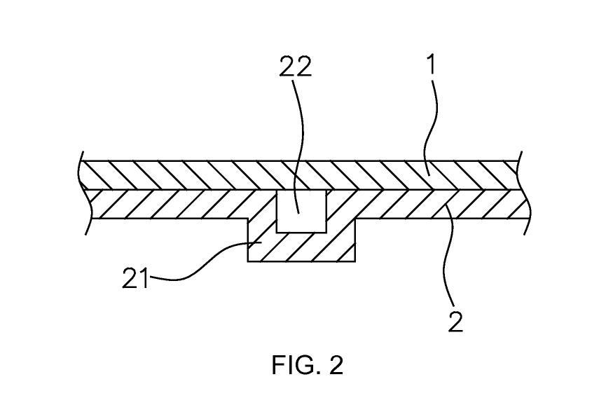

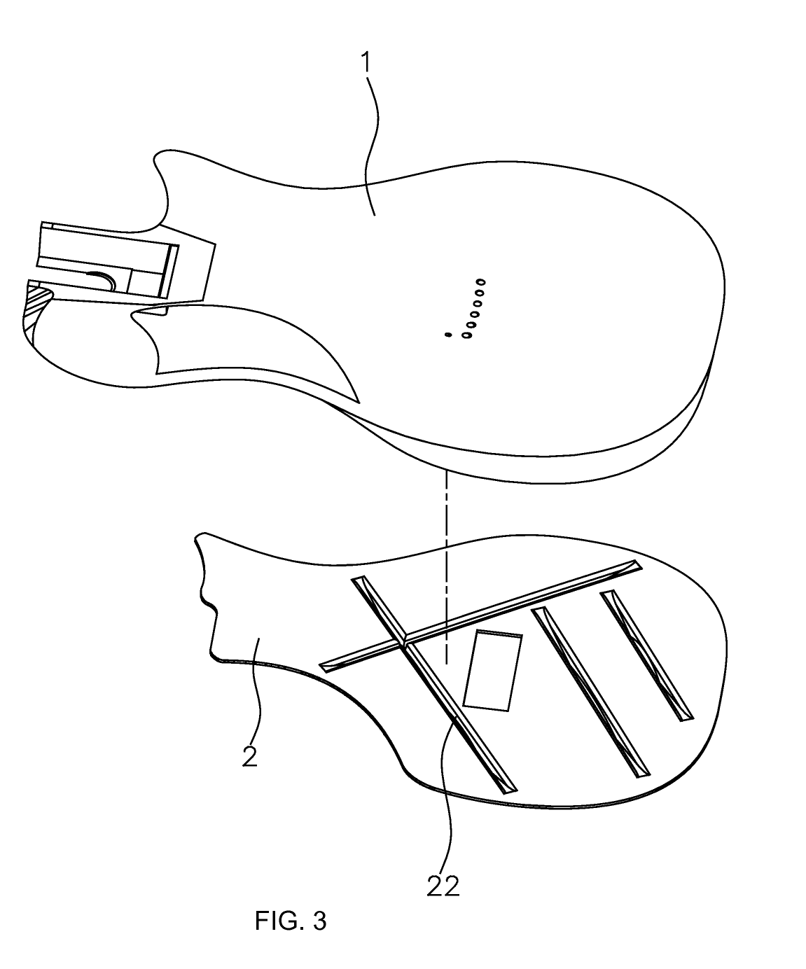

Referring to FIGS. 1 to 3, this invention is a soundboard construction for an acoustic string instrument. The instrument's sound box consists of a soundboard, back and side panels. The soundboard is formed by combining the outer panel 1 and inner panel 2, and there are a plurality of braces 22 which are molded or formed into the inner panel 2. The braces 22 are for enhancing the strength and forming the tone of the instrument.

The outer surface of panel 1 is a relatively uniformly flat or curved surface. Form an external surface view, the outer panel 1 may be composite or wood material, or may formed by layering or pressing compound materials with resin, such as carbon fiber, KEVLAR, glass fiber and other compound materials. Compound materials used in the construction may have a variety of weave or grain patterns, such as plain, twill, satin, or mono-directional. Compound materials may also be employed with no weave pattern at all. The outer panel 1 can be formed by mold tooling, cutting or stamping, and it can be formed with or without a high temperature manufacturing process.

The outer side of inner panel 2 is connected with inner side of outer panel 1 and combined to form the soundboard. The inner panel 2 can be made with any designed shape by molding or stamping. The inner panel 2 has recesses in it when looking from above at the braces 22, yet when looking from below it has what appear to be raised sections that are the braces 22. Material may also be added into the recesses 21 so as to make any desired tonal adjustments if needed.

The inner panel 2 is made of a lamination of compound materials, such as carbon fiber, KEVLAR, glass fiber and other compound materials with resin all joined together. Composite or natural material may employ different kinds of weaves such as plain, twill, satin, mono-directional weave and even non-woven materials may be employed. The inner panel 2 can be formed with or without a high temperature manufacturing process.

The outer panel 1 and inner panel 2 are combined together as an integrated soundboard construction. The thickness of the soundboard is preferably between 0.4-3.5 mm at its flat sections. After combining the outer side of the inner panel 2 with the outer panel 1, a hollow support construction will emerge due to the braces 22 on outer side of inner panel 2.

Of course, this compound material and construction may be employed for soundboard as well as for back and side panels. The side panels can be integrated with the soundboard or back panel to simply the manufacturing process.

The inner panel 2 is made with the braces 22 by molding with compound materials at one time directly, and then combining the inner panel 2 with the exterior outer panel 1 to form the complete soundboard of the instrument. In this case, not only does this reduce the cost of the instrument by reducing the percentage of wood used, but also achieves a stable tone from instrument to instrument due to the standard soundboard and support construction.

What is claimed is:

1. A string instrument soundboard for an instrument having a back and side panel comprises a combined outer panel and inner panel, the inner panel having a bracing structure formed into the inner panel for enhancing strength of the soundboard and for adjusting the tone of the instrument.

2. The string instrument soundboard of claim 1 wherein an outer side of the outer panel is a relatively flat or mildly curved surface.

3. The string instrument soundboard of claim 1 wherein the outer panel is constructed of a composite, man-made, or wood material.

4. The string instrument soundboard of claim 2 wherein the outer panel is constructed of a composite, man-made, or wood material.

5. The string instrument soundboard of claim 1 wherein the outer panel and inner panel are fixed together and together contain composite materials.

6. The string instrument soundboard of claim 2 wherein the outer panel and inner panel are fixed together and together contain composite materials.

7. The string instrument soundboard of claim 1 wherein the inner panel contains composite or natural materials with a weave pattern taken from the group of weave patterns consisting of plain, twill, satin, mono-directional, or non-woven.

8. The string instrument soundboard of claim 1 wherein the outer side of inner panel and the inner side of outer panel are combined to form the soundboard, and the inner panel is formed from a molding, stamping or die cutting process.

9. The string instrument soundboard of claim 1 wherein when an impression is made to form the shape of the inner panel, one side of the inner panel will have a raised structure, while the other side of the inner panel will have a corresponding recess.

10. The string instrument soundboard of claim 8 wherein when an impression is made to form the shape of the inner panel, one side of the inner panel will have a raised structure, while the other side of the inner panel will have a corresponding recess.

11. The string instrument soundboard of claim 9 wherein material may be added in the recess to enhance the strength of the soundboard and to modify the tone of the instrument.

12. The string instrument soundboard of claim 10 wherein material may be added in the recess to enhance the strength of the soundboard and to modify the tone of the instrument.

13. The string instrument soundboard of claim 1 wherein the outer panel and inner panel are glued together to form the soundboard having a thickness between 0.4-3.5 mm in areas where there is no recess formed in the inner panel.

14. The string instrument soundboard of claim 1 wherein the side panel and soundboard are integrally constructed.

15. The string instrument soundboard of claim 1 wherein the side panel and the back panel are integrally constructed.
